(19) United States
(12) Patent Application Publication
(10) Pub. No.: US 2026/0062050 A1
(43) Pub. Date: Mar. 5, 2026

(54) POWER PACK AND REAR WHEEL STEERING APPARATUS INCLUDING THE SAME

(71) Applicant: HYUNDAI MOBIS CO., LTD., Seoul (KR)

(72) Inventors: Kwang Yoon KIM, Yongin-si (KR); Seong Jun WOO, Yongin-si (KR); Sun Young CHEONG, Yongin-si (KR); Byuong Ook SON, Yongin-si (KR); Soon Ho BAEK, Yongin-si (KR)

(73) Assignee: HYUNDAI MOBIS CO., LTD., Seoul (KR)

(21) Appl. No.: 19/184,231

(22) Filed: Apr. 21, 2025

(30) Foreign Application Priority Data
Aug. 27, 2024 (KR) 10-2024-0115260

(51) Int. Cl. B62D 7/15

(52) U.S. Cl. CPC B62D 7/1581; B62D 7/159

(57) ABSTRACT

A power pack including a motor shaft, the motor shaft being configured to rotate, a main gear, the main gear being configured to coaxially rotate with the motor shaft, a main gear magnet fixed to the main gear, a sub-gear, the sub-gear being configured to rotate in conjunction with the main gear, a sub-gear magnet fixed to the sub-gear, a main gear rotation detection sensor, the main gear rotation detection sensor being configured to detect a main gear rotation of the main gear from a change in a magnetic field of the main gear magnet, and a sub-gear rotation detection sensor, the sub-gear rotation detection sensor being configured to detect a sub-gear rotation of the sub-gear from a change in a magnetic field of the sub-gear magnet.

### CROSS-REFERENCE TO RELATED APPLICATION

This application claims priority from and the benefit under 35 USC § 119 of Korean Patent Application No. 10-2024-0115260, filed on Aug. 27, 2024, in the Korean Intellectual Property Office, the entire disclosure of which is incorporated by reference for all purposes.

### BACKGROUND

### 1. Field

The present disclosure relates to a power pack and a read wheel steering apparatus including the same and, more particularly, to a power pack capable of measuring a steering angle of a wheel and a rear wheel steering apparatus including the same.

### 2. Description of the Related Art

A rear wheel steering (RWS) apparatus is a type of all wheel steering (AWS) apparatus that can improve vehicle's responsiveness and driving safety and reduce a turning radius.

Typically, the rear wheel steering apparatus of a vehicle includes an electric motor, a screw nut that rotates by the power of the electric motor, and a lead screw coupled to the screw nut.

A male thread pattern is formed on an outer surface of the lead screw, and a female thread pattern that meshes with the male thread pattern of the lead screw is formed on an inner surface of the screw nut. Accordingly, when the screw nut is rotated by the power of the electric motor, the lead screw moves in a width direction of the vehicle. By such an operation, the rear wheels of the vehicle are steered.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a power pack including a motor shaft, the motor shaft being configured to rotate, a main gear, the main gear being configured to coaxially rotate with the motor shaft, a main gear magnet fixed to the main gear, a sub-gear, the sub-gear being configured to rotate in conjunction with the main gear, a sub-gear magnet fixed to the sub-gear, a main gear rotation detection sensor, the main gear rotation detection sensor being configured to detect a main gear rotation of the main gear from a change in a magnetic field of the main gear magnet, and a sub-gear rotation detection sensor, the sub-gear rotation detection sensor being configured to detect a sub-gear rotation of the sub-gear from a change in a magnetic field of the sub-gear magnet.

A motor axis, the motor axis being defined as a first center of the rotation of the motor shaft, and a sub-gear axis, the sub-gear axis being defined as a second center of the rotation of the sub-gear, may be parallel with each other.

The main gear rotation detection sensor may be located on the motor axis.

The sub-gear rotation detection sensor may be disposed on the sub-gear axis.

The power pack may include a motor position sensor, the motor position sensor being configured to detect a rotation angle of the motor shaft through the rotation of the main gear.

The power pack may include a circuit board on which the main gear rotation detection sensor, the sub-gear rotation detection sensor, and the motor position sensor are mounted.

The main gear rotation detection sensor and the sub-gear rotation detection sensor may be mounted on a first side of the circuit board facing the main gear and the sub-gear and the motor position sensor may be mounted on a second side of the circuit board, facing away from the first side.

The power pack may include a controller, the controller being configured to calculate a steering angle of a rear wheel at a start of driving of a vehicle, based on a detection signal generated from the main gear rotation detection sensor and a detection signal generated from the sub-gear rotation detection sensor when power supply to the power pack is initiated.

In a general aspect, here is provided a rear wheel steering apparatus including a steering shaft part extending in a width direction of a vehicle, the steering shaft part being configured to move in a width direction of the vehicle to change a rear wheel steering angle of the vehicle and a power pack including a rotatable motor shaft, the rotatable motor shaft being configured to provide power to move the steering shaft part in the width direction of the vehicle, a main gear, the main gear being configured to coaxially rotate with the rotatable motor shaft, a main gear magnet fixed to the main gear, a sub-gear, the sub-gear configured to rotate in conjunction with the main gear, a sub-gear magnet fixed to the sub-gear, a main gear rotation detection sensor, the main gear rotation detection sensor being configured to detect a main gear rotation of the main gear from a change in a magnetic field of the main gear magnet, and a sub-gear rotation detection sensor, the sub-gear rotation detection sensor being configured to detect a sub-gear rotation of the sub-gear from a change in a magnetic field of the sub-gear magnet.

The main gear may be coaxially coupled to a first side of the rotatable motor shaft and the steering shaft part may be coupled to a second side of the rotatable motor shaft, the steering shaft part being configured to transmit power.

In a general aspect, here is provided an apparatus including a motor shaft, a main gear, the main gear being configured to coaxially rotate with the motor shaft, a main gear magnet fixed to the main gear, a sub-gear, the sub-gear being configured to rotate in conjunction with the main gear, a sub-gear magnet fixed to the sub-gear, one or more processors configured to execute instructions, a memory storing the instructions, and an execution of the instructions configures the one or more processors to detect, by a main gear rotation detection sensor, a main gear rotation of the main gear from a change in a magnetic field of the main gear magnet and detect, by a sub-gear rotation detection sensor, a sub-gear rotation of the sub-gear from a change in a magnetic field of the sub-gear magnet.

The one or more processors may be further configured to calculate a steering angle of a rear wheel at a start of driving of a vehicle, based on a detection signal generated from the main gear rotation detection sensor and a detection signal generated from the sub-gear rotation detection sensor when a power supply to the apparatus is initiated.

The one or more processors may be further configured to detect, by a motor position sensor, a rotation angle of the motor shaft through the rotation of the main gear.

A motor axis, the motor axis being defined as a first center of the rotation of the motor shaft, and a sub-gear axis, the sub-gear axis being defined as a second center of the rotation of the sub-gear, may be parallel with each other.

### BRIEF DESCRIPTION OF THE DRAWINGS

FIG. 1 is a perspective view illustrating a rear wheel steering apparatus according to an embodiment of the present disclosure.

FIG. 2 is a cross-sectional view taken along line A-A in FIG. 1.

FIG. 3 is an exploded perspective view of a power pack in FIG. 1.

FIG. 4 is an exploded and enlarged perspective view illustrating a motor shaft, a main gear, a sub-gear, and a control circuit board in FIG. 3.

FIG. 5 is an exploded perspective view illustrating a motor shaft, a main gear, a sub-gear, and a control circuit board in FIG. 4, with a control circuit board positioned at the rear.

FIG. 6 is a side view of a main gear, a sub-gear, and a control circuit board in FIG. 4, extracted and illustrated.

FIG. 7 is an enlarged plan view illustrating a main gear and a sub-gear in FIG. 6.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

According to the present disclosure, a means for measuring the steering angle of a rear wheel is incorporated into the power pack. Accordingly, a sensor for measuring the displacement of the lead screw and a cable connecting the sensor and the power pack can be eliminated, making it easy to miniaturize the rear wheel steering apparatus and reducing the manufacturing cost of the rear wheel steering apparatus.

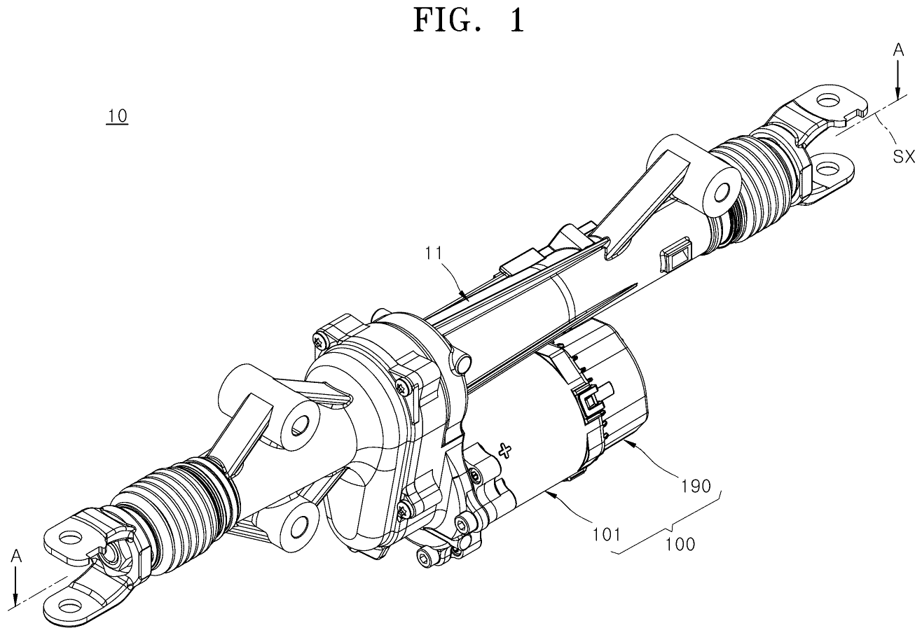

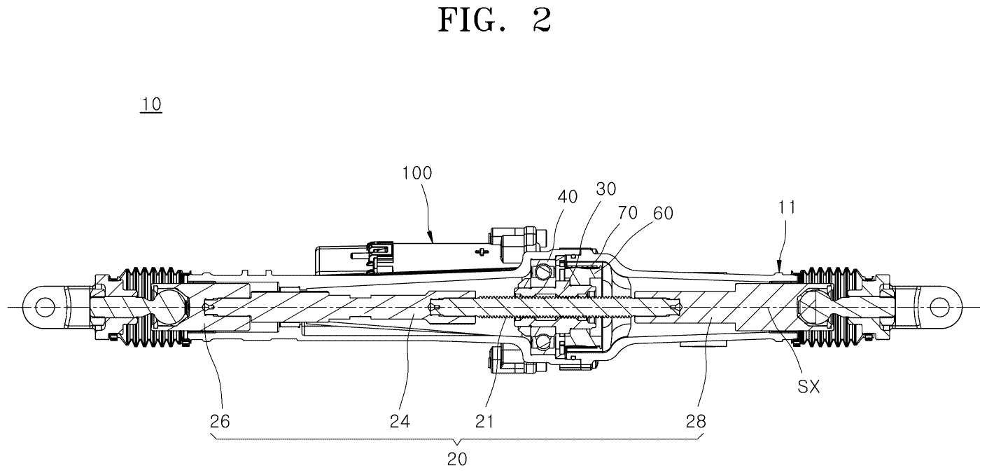

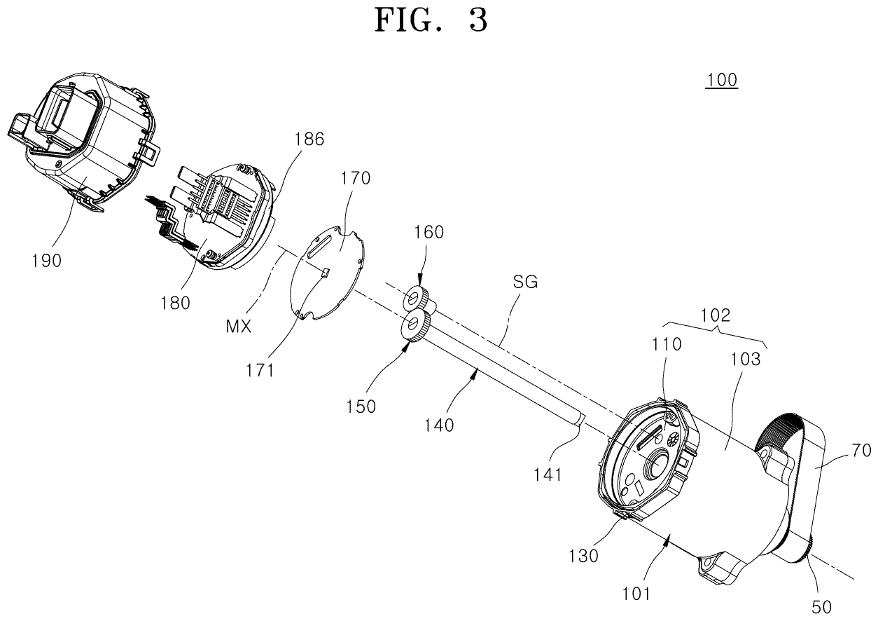

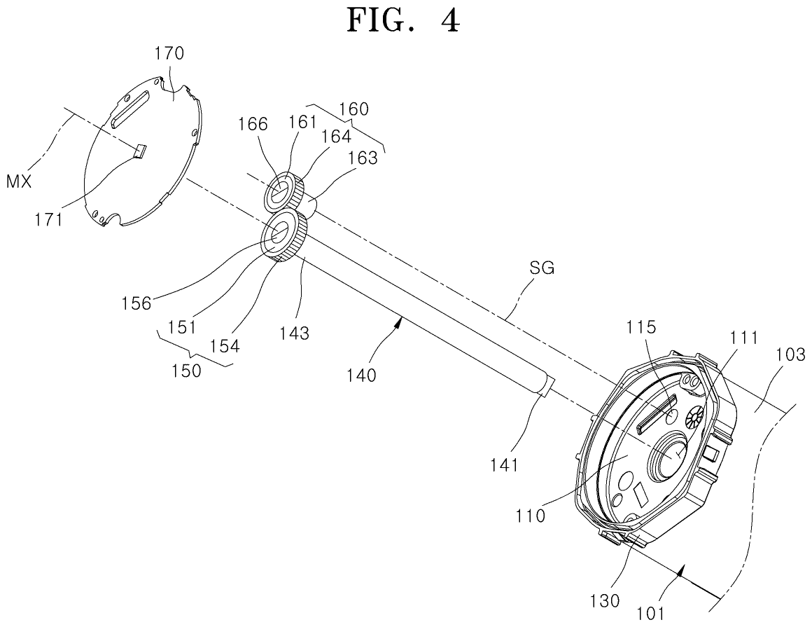

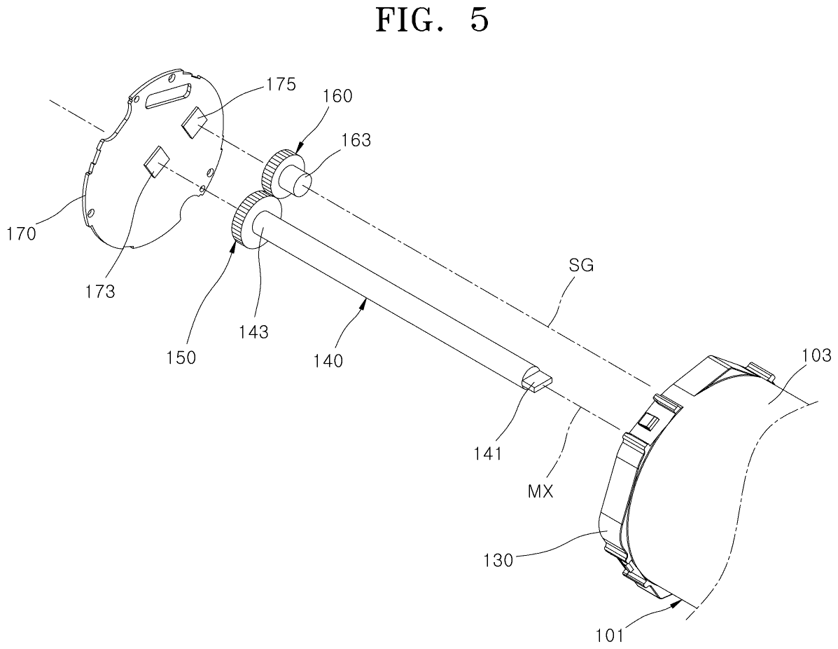

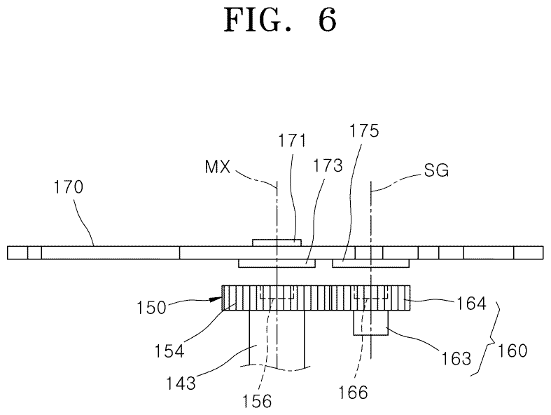

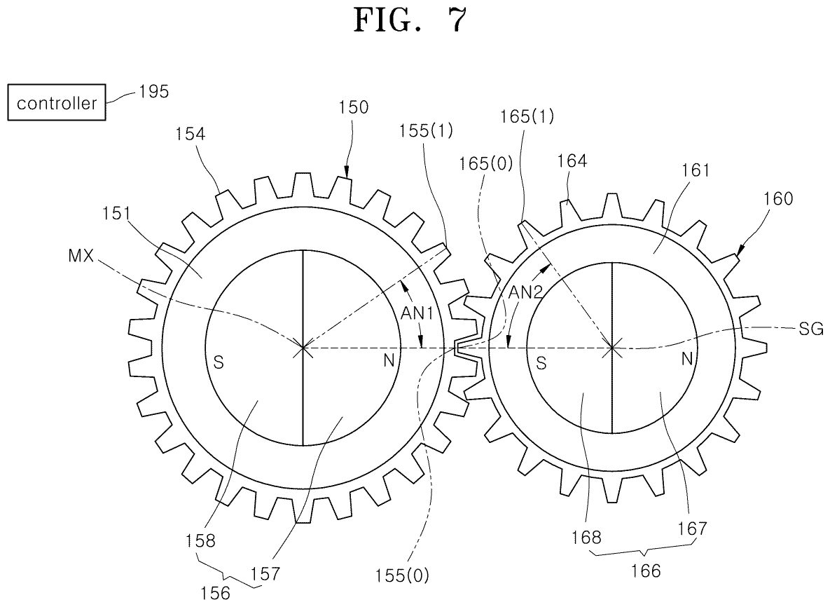

FIG. 1 is a perspective view illustrating a rear wheel steering apparatus according to an embodiment of the present disclosure. FIG. 2 is a cross-sectional view taken along line A-A in FIG. 1. FIG. 3 is an exploded perspective view illustrating a power pack in FIG. 1. FIG. 4 is an exploded and enlarged perspective view illustrating the motor shaft, the main gear, the sub-gear, and the control circuit board in FIG. 3, and illustrated. FIG. 5 is an exploded perspective view illustrating the motor shaft, the main gear, the sub-gear, and the control circuit board in FIG. 4, with the control circuit board positioned at the rear. FIG. 6 is a side view illustrating the main gear, the sub-gear, and the control circuit board in FIG. 4, extracted and illustrated. FIG. 7 is an exploded plan view of the main gear and a sub-gear in FIG. 6.

Referring to FIG. 1 to FIG. 7, the rear wheel steering apparatus 10 according to an embodiment of the present disclosure includes a steering shaft part 20 and a power pack 100. The steering shaft part 20 extends in a width direction of a vehicle (not shown). The steering shaft part 20 may move in the width direction of the vehicle to change a steering angle of rear wheels (not shown) of the vehicle.

The steering shaft part 20 includes a lead screw 21, a connecting shaft 24, a first socket 26, and a second socket 28. The lead screw 21 extends along an axis SX parallel to a longitudinal direction of the steering shaft part 20. The lead screw 21 may have a male thread pattern formed on an outer surface thereof.

The connecting shaft 24 extends along the axis SX and is coupled to a first side of the lead screw 21. The first socket 26 is coupled to a second side of the connecting shaft 24, opposite to the first side coupled to the lead screw 21. The second socket 28 is coupled to the second side of the lead screw 21, opposite to the first side coupled to the connecting shaft 24. A rear wheel part including, for example, rear wheels, a tie rod, a ball joint, etc. may be coupled to the first socket 26 and the second socket 28.

The rear wheel steering apparatus 10 further includes a housing 11, a screw nut 30, a bearing 40, a motor-side pulley 50, a nut-side pulley 60, and a belt 70. The housing 11 accommodates the steering shaft part 20, the screw nut 30, the bearing 40, the motor-side pulley 50, the nut-side pulley 60, and the belt 70 therein.

The lead screw 21 passes through the screw nut 30. A through hole through which the lead screw 21 passes is disposed at the screw nut 30. A female thread pattern that meshes with the male thread pattern of the lead screw 21 may be disposed on an inner surface of the through hole of the screw nut 30. The bearing 40 rotatably supports the screw nut 30 with respect to the housing 11.

The motor-side pulley 50 is rotated by the power of an electric motor 101 of the power pack 100. The nut-side pulley 60 is closely fixed to an outer surface of the screw nut 30 to be spaced apart from the bearing 40 in a direction of the axis SX. The belt 70 is wound around the motor-side pulley 50 and the nut-side pulley 60 to connect the motor-side pulley 50 and the nut-side pulley 60 to each other to enable power transmission.

When a motor shaft 140 of the electric motor 101 rotates and the motor-side pulley 50 rotates, the belt 70 is supported by the motor-side pulley 50 and the nut-side pulley 60 to run on an endless track, and the nut-side pulley 60 and the screw nut 30 rotate around the axis SX. As the screw nut 30 rotates, the steering shaft part 20 moves in the width direction of the vehicle along the axis SX, and as a result, the rear wheels (not shown) can be steered.

Meanwhile, the rear wheel steering apparatus according to another embodiment of the present disclosure may include a steering shaft part including, for example, a rack bar instead of the steering shaft part including the lead screw. In this case, the rear wheel steering apparatus may include a pinion coaxially coupled to a motor shaft of the electric motor instead of the screw nut, the motor-side pulley, the nut-side pulley, and the belt.

The power pack 100 provides power to move the steering shaft part 20 in the width direction of the vehicle, that is, in the direction of the axis SX. The power pack 100 includes the motor shaft 140, a main gear 150, a main gear magnet 156, a sub-gear 160, a sub-gear magnet 166, a main gear rotation detection sensor 173, and a sub-gear rotation detection sensor 175.

The motor shaft 140 extends along a motor axis MX parallel to the axis SX of the steering shaft part 20, and rotates around the motor axis MX.

The power pack 100 further includes the electric motor 101 and a power pack cover 190. The electric motor 101 includes a motor housing 102 and a motor shaft 140. The motor housing 102 includes a cylinder part 103 and a bottom plate part 110. A stator (not shown) may be installed in an internal space of the cylinder part 103.

One side of the cylinder part 03 is open, and the stator may be inserted and installed into the internal space through the open side of the cylinder part 103. The bottom plate part 110 may be coupled to the cylinder part 103 to close the open side of the cylinder part 103.

The motor shaft 140 passes through the motor housing 102. A motor shaft hole 111 is disposed in the bottom plate part 110 so that a first side of the motor shaft 140 protrudes outward the bottom plate part 110. A second side of the motor shaft 140 protrudes outward the cylinder part 103. Inside the cylinder part 103, the stator may surround the motor shaft 140.

The main gear 150 may be coaxially coupled to one end 143 of the motor shaft 140 protruding outward the bottom plate part 110. The motor-side pulley 50 may be coaxially coupled to the other end 141 of the motor shaft 140 protruding outward the cylinder part 103.

Accordingly, the steering shaft part 20 can be connected to the other end 141 of the motor shaft 140 so as to be capable of transmitting power. When the motor shaft 140 rotates around the motor axis MX, the steering shaft part 20 moves in the width direction of the vehicle along the axis SX, and the rear wheels can be steered by tilting to the left or right.

The power pack cover 190 is coupled to the motor housing 102. The motor housing 102 further includes a coupling flange 130 on an outer periphery of the cylinder part 103 such that the power pack cover 190 is coupled to the motor housing 102. An internal space isolated from the outside may be formed by the bottom plate part 110 of the motor housing 102 and the power pack cover 190.

The main gear 150 rotates coaxially with the motor shaft 140. The main gear 150 includes a circular main gear body 151 coupled and fixed to one end 143 of the motor shaft 140 and a plurality of gear teeth 154 provided on an outer surface of the main gear body 151.

The main gear magnet 156 is mounted and fixed on the main gear 150. For example, the main gear magnet 156 may be mounted and fixed in a magnet mounting groove formed on the main gear body 151. The main gear magnet 156 may be located on, for example, the motor axis MX. The main gear magnet 156 may be a permanent magnet. The main gear magnet 156 has a halved N pole region 157 and S pole region 158.

The sub-gear 160 rotates in conjunction with the main gear 150. The sub-gear 160 may be rotatably coupled to, for example, the bottom plate part 110. A sub-gear axis SG, the rotation center of the sub-gear 160, is parallel to the motor shaft 140 and the motor axis MX that is the rotation center of the main gear 150.

The sub-gear 160 includes a pillar 163 rotatably coupled to a sub-gear coupling part 115 of the bottom plate part 110, a circular sub-gear body 161 coupled and fixed to the pillar 163, and a plurality of gear teeth 164 provided on an outer surface of the sub-gear body 161.

The gear teeth 164 of the sub-gear 160 mesh with the gear teeth 154 of the main gear 150, so that the sub-gear 160 can rotate along with the rotation of the main gear 150. A diameter of the sub-gear 160 may be smaller than a diameter of the main gear 150. However, in another embodiment of the present disclosure, the diameter of the sub-gear 160 may be larger than or equal to the diameter of the main gear 150.

The number of gear teeth 154 of the main gear 150 and the number of gear teeth 164 of the sub gear 160 may be the same or different. Accordingly, the rotation ratios of the main gear 150 and the sub gear 160 may be different. According to the embodiment illustrated in the drawings, the number of gear teeth 154 of the main gear 150 may be greater than the number of gear teeth 164 of the sub gear 160.

The sub-gear magnet 166 is mounted and fixed on the sub-gear 150. For example, the sub-gear magnet 166 is mounted and fixed in a magnet mounting groove formed on the sub-gear body 161. The sub-gear magnet 166 may be located on, for example, the sub-gear axis line SG. The sub-gear magnet 166 may be a permanent magnet. The sub-gear magnet 166 has a halved N pole region 167 and S pole region 168.

The main gear rotation detection sensor 173 detects the rotation of the main gear 150 from a change in the magnetic field of the main gear magnet 156. The sub-gear rotation detection sensor 175 detects the rotation of the sub-gear 166 from a change in the magnetic field of the sub-gear magnet 166. The main gear rotation detection sensor 173 may be located on the motor axis MX, and the sub-gear rotation detection sensor 175 may be located on the sub-gear axis SG.

The power pack 100 further includes a control circuit board 170, a power circuit board 180, connectors 183 and 184, and a heat sink 186. The main gear 150, the main gear magnet 156, the sub-gear 160, the sub-gear magnet 166, the main gear rotation detection sensor 173, the sub-gear rotation detection sensor 175, the control circuit board 170, the power circuit board 180, the connectors 183 and 184, and the heat sink 186 may be accommodated in an internal space defined by the bottom plate part 110 of the motor housing 102 and the power pack cover 190.

The control circuit board 170 may include a circuit that generates a control signal for controlling the operation of the electric motor 101. The power circuit board 180 may include a circuit that supplies driving power to the electric motor 101. A connector that supplies the driving power to the electric motor 101 may be mounted on the power circuit board 180. The heat sink 186 is located between the power circuit board 180 and the control circuit board 170. The heat sink 186 may promote heat dissipation of the power circuit board 180.

Referring to FIG. 7, an example of a method of measuring a steering angle of a rear wheel is as follows. When a reference point 155 set on the outer surface of the main gear 150 and a reference point 165 set on the outer surface of the sub-gear 160 are in contact with each other, that is, when the reference point 155 of the main gear 150 is at a position of 155(0) and the reference point 165 of the sub-gear 160 is at a position of 165(0), the steering angle of the rear wheel may be 0° with respect to the longitudinal direction of the vehicle.

In the embodiment illustrated in FIG. 7, because the number of gear teeth 154 of the main gear 150 and the number of gear teeth 164 of the sub-gear 160 are different, when the steering angle of the rear wheel is changed by the rotation of the motor shaft 140, the reference point 155 of the main gear 150 may rotate counterclockwise with respect to the motor axis MX by a first angle AN1 and move to a position of ‘155(1)’, and the reference point 165 of the sub-gear 160 may rotate clockwise with respect to the sub-gear axis SG by a second angle AN2 and move to a position of ‘165(1)’.

The steering angle of the rear wheel may be determined by the relationship between the first angle AN1 and the second angle AN2. For example, the steering angle of the rear wheel may be increased as the value obtained by subtracting the value of the first angle AN1 from the value of the second angle AN2 becomes larger.

In this manner, when the steering angle of the rear wheel is measured, the steering angle of the rear wheel can be calculated at the time of starting driving the vehicle, that is, at the time of starting operation of the vehicle. In other words, when a power switch of the vehicle is pressed while the rear wheel steering angle is not aligned to 0° to terminate the operation of the vehicle and the power switch of the vehicle is pressed again to restart the operation, the steering angle of the rear wheel can be measured at the time the vehicle operation starts and can be notified to the driver, thereby assisting a driver in driving safely.

The power pack 100 further includes a controller 195. The controller 195 calculates the steering angle of the rear wheel at the start of driving of the vehicle, based on a detection signal generated from the main gear rotation detection sensor 173 and a detection signal generated from the sub-gear rotation detection sensor 175 when power supply to the power pack 100 is initiated. The controller 195 may be included in an ECU of the vehicle. Alternatively, the controller 195 may be included in the control circuit board 170. In an example, the controller 195 may include one or more processors and a memory storing instructions to configure the processors to perform one or more operations.

The power pack 100 further includes a motor position sensor 171 that detects the rotation angle of the motor shaft 140 through the rotation of the main gear 150. The motor position sensor 171 may be located on the motor axis MX.

The main gear rotation detection sensor 173, the sub-gear rotation detection sensor 175, and the motor position sensor 171 are mounted on the control circuit board 170. The main gear rotation detection sensor 173 and the sub-gear rotation detection sensor 175 are mounted on a first side of the control circuit board 170 facing the main gear 150 and the sub-gear 160.

The motor position sensor 171 is mounted on the first side of the control circuit board 170, facing away from a second side of the control circuit board 170. In detail, the main gear rotation detection sensor 173 and the motor position sensor 171 are disposed facing away from each other on the motor axis MX with the control circuit board 170 therebetween.

Each of the main gear rotation detection sensor 173, the sub-gear rotation detection sensor 175, and the motor position sensor 171 may include, for example, a Hall sensor. The resolution of the motor position sensor 171 may be greater than the resolution of the main gear rotation detection sensor 173 and the resolution of the sub-gear rotation detection sensor 175. Accordingly, the detection accuracy of the motor position sensor 171 may be higher than the accuracy of the main gear rotation detection sensor 173 and the accuracy of the sub-gear rotation detection sensor 175. In addition, the detection speed of the motor position sensor 171 may be faster than the detection speed of the main gear rotation detection sensor 173 and the detection speed of the sub-gear rotation detection sensor 175.

The motor position sensor 171 may reset the rotation angle of the motor shaft 140 when power supply to the power pack 100 is initiated. In other words, the change in the steering angle of the rear wheel may be detected in real time after the power supply is initiated through the detection signal of the motor position sensor 171, but the steering angle of the rear wheel may not be detected at the detection time.

The controller 195 calculates the steering angle of the rear wheel during operation of the vehicle, based on the detection signal generated by the motor position sensor 171 during the operation of the vehicle and the steering angle of the rear wheels at the time of the start of operation. In other words, the controller 195 calculates the steering angle of the rear wheels in real time during the operation of the vehicle by adding the steering angle of the rear wheels at the time of the start of operation of the vehicle, which is detected by the detection signal of the main gear rotation detection sensor 173 and the detection signal of the sub-gear rotation detection sensor 175, and the change in the steering angle detected by the detection signal of the motor position sensor 171 during the operation of the vehicle.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Implementations described herein may be realized as a method or process, an apparatus, a software program, a data stream or a signal, for example. Examples having a discussed characteristic may also be realized in another form (e.g., apparatus or program). The apparatus may be implemented as proper hardware, software or firmware. The method may be implemented in an apparatus (e.g., the controller 195), such as a processor commonly referring to a processing device, including a computer, a microprocessor, an integrated circuit or a programmable logic device, for example. The processor may be associated with a memory and the memory may include computer-readable instructions. The processor may be configured to execute computer-readable instructions, such as those stored in the memory, and through execution of the computer-readable instructions, the processor is configured to perform one or more, or any combination, of the operations and/or methods described herein. The memory may be a volatile or nonvolatile memory.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A power pack, comprising:
a motor shaft, the motor shaft being configured to rotate;
a main gear, the main gear being configured to coaxially rotate with the motor shaft;
a main gear magnet fixed to the main gear;
a sub-gear, the sub-gear being configured to rotate in conjunction with the main gear;
a sub-gear magnet fixed to the sub-gear;
a main gear rotation detection sensor, the main gear rotation detection sensor being configured to detect a main gear rotation of the main gear from a change in a magnetic field of the main gear magnet; and
a sub-gear rotation detection sensor, the sub-gear rotation detection sensor being configured to detect a sub-gear rotation of the sub-gear from a change in a magnetic field of the sub-gear magnet.

2. The power pack of claim 1, wherein a motor axis, the motor axis being defined as a first center of the rotation of the motor shaft, and a sub-gear axis, the sub-gear axis being defined as a second center of the rotation of the sub-gear, are parallel with each other.

3. The power pack of claim 2, wherein the main gear rotation detection sensor is located on the motor axis.

4. The power pack of claim 2, wherein the sub-gear rotation detection sensor is disposed on the sub-gear axis.

5. The power pack of claim 1, further comprising:
a motor position sensor, the motor position sensor being configured to detect a rotation angle of the motor shaft through the rotation of the main gear.

6. The power pack of claim 5, further comprising:
a circuit board on which the main gear rotation detection sensor, the sub-gear rotation detection sensor, and the motor position sensor are mounted.

7. The power pack of claim 6, wherein the main gear rotation detection sensor and the sub-gear rotation detection sensor are mounted on a first side of the circuit board facing the main gear and the sub-gear, and
wherein the motor position sensor is mounted on a second side of the circuit board, facing away from the first side.

8. The power pack of claim 5, further comprising:
a controller, the controller being configured to calculate a steering angle of a rear wheel at a start of driving of a vehicle, based on a detection signal generated from the main gear rotation detection sensor and a detection signal generated from the sub-gear rotation detection sensor when power supply to the power pack is initiated.

9. A rear wheel steering apparatus, comprising:
a steering shaft part extending in a width direction of a vehicle, the steering shaft part being configured to move in a width direction of the vehicle to change a rear wheel steering angle of the vehicle; and
a power pack comprising:
a rotatable motor shaft, the rotatable motor shaft being configured to provide power to move the steering shaft part in the width direction of the vehicle;
a main gear, the main gear being configured to coaxially rotate with the rotatable motor shaft;
a main gear magnet fixed to the main gear;
a sub-gear, the sub-gear configured to rotate in conjunction with the main gear;
a sub-gear magnet fixed to the sub-gear;
a main gear rotation detection sensor, the main gear rotation detection sensor being configured to detect a main gear rotation of the main gear from a change in a magnetic field of the main gear magnet; and
a sub-gear rotation detection sensor, the sub-gear rotation detection sensor being configured to detect a sub-gear rotation of the sub-gear from a change in a magnetic field of the sub-gear magnet.

10. The rear wheel steering apparatus of claim 9, wherein the main gear is coaxially coupled to a first side of the rotatable motor shaft, and
wherein the steering shaft part is coupled to a second side of the rotatable motor shaft, the steering shaft part being configured to transmit power.

11. An apparatus, comprising:
a motor shaft;
a main gear, the main gear being configured to coaxially rotate with the motor shaft;
a main gear magnet fixed to the main gear;
a sub-gear, the sub-gear being configured to rotate in conjunction with the main gear;
a sub-gear magnet fixed to the sub-gear;
one or more processors configured to execute instructions; and
a memory storing the instructions, wherein execution of the instructions configures the one or more processors to:
detect, by a main gear rotation detection sensor, a main gear rotation of the main gear from a change in a magnetic field of the main gear magnet; and
detect, by a sub-gear rotation detection sensor, a sub-gear rotation of the sub-gear from a change in a magnetic field of the sub-gear magnet.

12. The apparatus of claim 11, wherein the one or more processors are further configured to:
calculate a steering angle of a rear wheel at a start of driving of a vehicle, based on a detection signal generated from the main gear rotation detection sensor and a detection signal generated from the sub-gear rotation detection sensor when a power supply to the apparatus is initiated.

13. The apparatus of claim 11, wherein the one or more processors are further configured to:
detect, by a motor position sensor, a rotation angle of the motor shaft through the rotation of the main gear.

14. The apparatus of claim 11, wherein a motor axis, the motor axis being defined as a first center of the rotation of the motor shaft, and a sub-gear axis, the sub-gear axis being defined as a second center of the rotation of the sub-gear, are parallel with each other.
